(19) United States
(12) Patent Application Publication
(10) Pub. No.: US 2026/0297415 A1
(43) Pub. Date: Oct. 1, 2026

(54) HIGH TEMPERATURE UNIVERSAL FLUIDS AND METHODS AND SYSTEMS RELATED THERETO

(71) Applicant: ARAMCO SERVICES COMPANY, Houston, TX (US)

(72) Inventors: Guoqing JIAN, Houston, TX (US); Ashok SANTRA, The Woodlands, TX (US); Arthur HALE, Houston, TX (US); Qusai A. DARUGAR, Houston, TX (US)

(73) Assignee: ARAMCO SERVICES COMPANY, Houston, TX (US)

(21) Appl. No.: 19/094,645

(22) Filed: Mar. 28, 2025

(51) Int. Cl. C09K 8/487; C09K 8/12

(52) U.S. Cl. CPC C09K 8/487; C09K 8/12

(57) ABSTRACT

Flowable universal fluid (UF) compositions comprising an aqueous-based carrier fluid; an aluminosilicate material; a set retarding agent; a polyacrylamide viscosifier; and a fluid loss control agent, exhibiting a HTHP fluid loss volume of 10-50 mL; and/or filter cake thickness of from 5/32″ to 1″, as measured by API 13B-1 (2023). Methods comprising providing the flowable UF composition; drilling a wellbore in a subterranean formation using the flowable UF composition, wherein at least a portion thereof remains in the wellbore upon completion of the drilling; and introducing an alkaline activator into the wellbore, thereby contacting the remaining flowable UF composition therein with the alkaline activator; and allowing the activated flowable UF composition in the wellbore to solidify under formation temperature conditions, thereby forming a solidified UF composition in the wellbore.

### FIELD OF THE DISCLOSURE

The present disclosure relates generally to wellbore drilling and/or cementing operations in the oil and gas industry; more particularly, the present disclosure relates to high temperature drilling and cementing universal fluids, and methods and systems related thereto.

### BACKGROUND OF THE DISCLOSURE

The production of crude oil and other hydrocarbons begins with the drilling of a wellbore through a subterranean formation and into a hydrocarbon reservoir. Drilling of a wellbore generally involves circulating a drilling fluid (or drilling mud) from a surface location of the wellbore to a downhole location through a drill string. The drilling fluid exits through ports (or jets) in a drill bit, which bores through the formation and forms the wellbore. The drilling fluid aids in cooling and lubricating the drill bit and further picks up cuttings and carries the cuttings up an annulus (also referred to herein as an annular area) formed between an inner wall of the wellbore and an outer wall of the drill string. The drilling fluid and the cuttings flow through the annulus to the surface, where the cuttings are separated from the fluid. For various environmental, sustainability, and practical reasons, aqueous-based drilling fluids may be preferred for wellbore drilling operations.

The wellbore may be isolated from the surrounding subterranean formation using a cementing operation. During a cementing operation, a cement sheath is placed within a wellbore between the subterranean formation and a casing (or liner string). The cement sheath is formed by pumping a cement slurry through the bottom of the casing and out through the annulus between the outer casing wall and the formation face of the wellbore. The cement slurry then cures in the annular space, thereby forming a sheath of hardened cement that, among other functions, supports and positions the casing in the wellbore and bonds the exterior surface of the casing to the subterranean formation.

The transition between a drilling operation and a cementing operation may result in various issues that require additional remedial steps, such as for example, operator costs associated with time, economic expenditures, and equipment wear and tear. For example, after performing a drilling operation, residual aqueous-based drilling fluid may remain within the drilled wellbore, presenting significant challenges related to, for example, zonal isolation due to unstable and/or poor cement bonding, mud-channeling, or other fluid migration-related interferences.

Indeed, fluid loss (or lost circulation) is a common form of such residual drilling fluid, in which the drilling fluid is imbibed or otherwise seeps into the pore matrix of a subterranean formation. Fluid loss can occur in various subterranean formations, such as naturally fractured formations, cavernous formations, and highly permeable formations (e.g., formations having a permeability greater than 500 millidarcy), regardless of the wellbore geometry (e.g., horizontal, vertical, deviated, or otherwise tortuous).

Traditionally, to address the challenges encountered when transitioning between a drilling operation and a cementing operation, after drilling and prior to cementing, a clean-up spacer fluid is utilized to cleanse the drilling fluid from the wellbore. However, such spacer fluid does not always fully displace the drilling fluid and may be ineffective at displacing drilling fluids, including associated formed filter cake, in near wellbore fractures or high permeability layers. Moreover, such spacer fluids themselves tend to be aqueous-based and may not fully be recovered from the wellbore to the surface, thus failing to remedy the above challenges.

In view of the aforementioned, a need exists for an ecologically and economically friendly universal fluid for use in both drilling and cementing operations related to a wellbore for use in the oil and gas industry.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, flowable universal fluid (UF) composition is provided, including: a mixture of: an aqueous-based carrier fluid; an aluminosilicate material; a set retarding agent; a polyacrylamide viscosifier; and a fluid loss control agent; wherein the flowable UF composition exhibits: a HTHP fluid loss volume of from 10 milliliters (mL) to 50 mL; and/or a HTHP filter cake thickness of from 5/32″ to 1″, as measured by API 13B-1 (2023); and wherein, upon contact with an alkaline activator, the activated flowable UF composition is capable of solidifying under formation temperature conditions, thereby forming a solidified UF composition.

In another embodiment consistent with the present disclosure, a method is provided including: providing a flowable universal fluid (UF) comprising: a mixture of: an aqueous-based carrier fluid; an aluminosilicate material; a set retarding agent; a polyacrylamide viscosifier; and a fluid loss control agent, wherein the flowable UF composition exhibits: a HTHP fluid loss volume of from 10 milliliters (mL) to 50 mL; and/or a HTHP filter cake thickness of from 5/32″ to 1″, as measured by API 13B-1 (2023); drilling a wellbore in a subterranean formation using the flowable UF composition, wherein at least a portion of the flowable UF composition remains in the wellbore upon completion of the drilling; introducing an alkaline activator into the wellbore, thereby contacting the remaining flowable UF composition therein with the alkaline activator; and allowing the activated flowable UF composition in the wellbore to solidify under formation temperature conditions, thereby forming a solidified UF composition in the wellbore.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIGS. 1A-1C show an incomplete cement displacement process, as described below in the Examples. FIG. 1A shows the cement displacement process where cement displaces drilling mud within the annulus (also referred to herein as the annular space, i.e., the space between the casing and the surrounding formation). FIG. 1B shows a schematic of incomplete cement displacement, which results in residual drilling fluid (e.g., drilling mud) in the annulus. FIG. 1C shows a photograph of fluid channels resulting from residual drilling fluid after incomplete cement displacement. Images taken from: Watson, Theresa, Don Getzlaf, and James E. Griffith. “Specialized Cement Design and Placement Procedures Prove Successful for Mitigating Casing Vent Flows—Case Histories.” SPE Gas Technology Symposium. OnePetro, 2002; and Counsel, C. (2011), National Commission on the BP Deepwater Horizon Oil Spill and Offshore Drilling: Macondo the Gulf Oil Disaster. United States. 2012.

FIG. 2 shows a comparison of the compositions of slag versus Class-G Portland cement particles as described below in the Examples.

FIG. 3 shows a schematic of the formation of a filter cake and the generation of a filtrate during an American Petroleum Institute (API) High Temperature High Pressure (HTHP) fluid loss test as described below in the Examples.

FIG. 4 shows the composition of a fly ash cement precursor and a blast furnace slag cement precursor for use in a UF composition based on x-ray fluorescence spectroscopy (XRF) analysis, as described below in the Examples.

FIG. 5 shows the chemical reactions involved in the geopolymerization of silica and alumina materials under alkaline conditions, as described below in the Examples.

FIG. 6 shows the thickening time of alkali-activated fly ash-based UF fluid as described below in the Examples.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to wellbore drilling and/or cementing operations in the oil and gas industry; more particularly, the present disclosure relates to high temperature universal fluids for drilling and cementing operations, and methods and systems related thereto.

The present disclosure provides a universal fluid (“UF”) composition, and related methods and systems, for use as a dual drilling fluid and cementing fluid. More specifically, the UF composition transforms from a fluid state, suitable for use as a drilling fluid, to a solid state, suitable to act as a high-strength cement over time. In an embodiment, an activator is used to control the timing of the transition from fluid to solid. Advantageously, the UF compositions described herein allow for the transformation of any residual UF composition remaining in a wellbore into a portion of a cement sheath, alleviating the various challenges discussed above. Moreover, beneficially, the UF compositions of the present disclosure may eliminate the need for remedial clean-up spacer fluids traditionally placed between drilling fluids and cementing fluids. Another advantage of the UF compositions described herein is increased bonding strength of the cured cement sheath between the subterranean formation and casing due to the similarity of composition of the UF composition in the inactivated and activated states compared to traditional drilling and cement fluid bonding strength. Further, the UF compositions of the present disclosure utilize environmentally friendly, sustainable materials to reduce the carbon footprint without compromising or improving field-ready rheology, high-strength cement, controllable mud-to-cement transition, and fluid loss control.

### Definitions

As used herein, the term “subterranean formation,” and grammatical variants thereof, refers to a rock beneath a surface of the Earth, whether a land surface or subsea surface, for which crude oil or hydrocarbons can be recovered. The rock may comprise, for example, shale, sandstone-based rock, carbonate-based rock, and the like.

As used herein, the term “wellbore,” and grammatical variants thereof, refers to a drilled hole or borehole, including an open hole or uncased portion of the wellbore, within a subterranean formation. A wellbore may be of any geometry, including vertical, horizontal, deviated, or otherwise tortuous.

As used herein, the terms “downhole,” and grammatical variants thereof, refers to the subsurface point of greatest penetration or depth in a wellbore.

As used herein, the term “formation temperature conditions,” and grammatical variants thereof, refers to downhole temperature conditions, e.g., temperature conditions of from about 49° C. (120° F.) to about 204° C. (400° F.), or greater, including all temperature values and subranges therebetween (e.g., at least about 66° F. (150° F.), at least about 93° C. (200° F.), at least about 121° C. (250° F.), at least about 149° C. (300° F.), or at least about 177° C. (350° F.), or from about 66° F. (150° F.) to about 177° C. (350° F.), or from about 93° C. (200° F.) to about 149° C. (300° F.), or from about 121° C. (250° F.)).

As used herein, the term “formation pressure conditions,” and grammatical variants thereof, refers to downhole pressure conditions, e.g., pressure conditions which correspond to formation temperature conditions, e.g., pressure conditions of from about 5,000 pounds per square inch (psi) to about 20,000 psi, or greater, including all pressure values and subranges therebetween (e.g., from about 5,000 psi to about 10,000 psi, from about 10,000 psi to about 15,000 psi, from about 15,000 psi to about 20,000 psi).

As used herein, the term “fluid loss zone,” and grammatical variants thereof, refers to a target zone of interest in a wellbore in which fluid loss occurs. A fluid loss zone may encompass an area encountered during various subterranean formation operations (e.g., drilling operations, cementing operations) where a volume of a treatment fluid is imbibed by a subterranean formation through a wellbore wall. A rate of loss of 1 to 10 barrels per hour (bbl/h) is characterized as seepage-loss that may occur in any formation; a rate of loss of 10 to less than 500 bbl/h is characterized as moderate-loss that may occur in porous formations or those having relatively small natural or induced fractures; and a rate of loss of equal to or greater than 500 bbl/h is characterized as severe loss that may occur in highly permeable formations or those having relatively large natural or induced fractures. Severe loss may include total fluid loss; severe loss can result in complete abandonment of a well.

As used herein, the term “aluminosilicate material”, and grammatical variants thereof, refers to a material comprising one or more geopolymer precursors. Aluminosilicate materials of the present disclosure comprise reactive amorphous aluminum and silicon oxides, minerals thereof, derivatives thereof, oligomers thereof, or any combination thereof.

Aluminosilicate materials of the present disclosure are activated by an alkaline activator in the presence of heat, and thus undergo a geopolymerization reaction to form a solidified UF composition of the present disclosure.

As used herein, the term “geopolymerization,” and grammatical variants thereof, refers to the polymerization of an aluminosilicate material by an alkaline activator in the presence of heat (e.g., under formation temperature conditions), thus forming a geopolymer. As used herein, the term “geopolymer,” and grammatical variants thereof, refers to a solid, three-dimensional tetrahedral silicon oxide network in which aluminum is substituted for silicon in at least a portion of the tetrahedral positions. In various embodiments, a geopolymer comprises linkages selected from: Si—S; Si—O; Al—O; Si—O—Si; Al—O—Al; Si—O—Al; Si—O—Al—O; Si—O—Al—O—Si—O; Si—O—Al—O—Si—O—Si—O; and any combination thereof.

As used herein, the term “flowable UF composition,” and grammatical variants thereof, refers to a UF composition of the present disclosure that is pumpable and suitable for use as a drilling fluid. A flowable UF composition is characterized as a flowable liquid-phase that may comprise various solid and/or gaseous states of matter dispersed throughout, which flow with the flowable liquid-phase. Flowable UF compositions of the present disclosure are usable for drilling operations in a wellbore in a subterranean formation. A flowable UF composition of the present disclosure will comprise an aluminosilicate material in an inactivated state. As used herein, the terms “inactivated” or “inactivated state,” and grammatical variants thereof, refer to an aluminosilicate material of the present disclosure which has yet to be activated by an alkaline activator in the presence of heat (e.g., under formation temperature conditions). As used herein, the terms “activated” and “activated state,” and grammatical variants thereof, refer to an aluminosilicate material of the present disclosure which have been activated by an alkaline activator in the presence of heat (e.g., under formation temperature conditions), thereby initiating a geopolymerization reaction therein.

As used herein, the term “set retarding agent,” and grammatical variants thereof, refers to a substance that can prevent undesired polymerization of flowable UF compositions of the present disclosure. In addition to the geopolymerization reaction disclosed herein, aluminosilicate materials of the present disclosure are susceptible to various other polymerization reactions, including, but not limited to, pozzolanic reactions, alkali-silica reaction (ASR), alkali-carbonate reaction (ACR), the like, and any combination thereof. As used herein, the term “pozzolanic reaction,” and grammatical variations thereof, refers to the polymerization reaction of finely ground siliceous and aluminous materials with calcium hydroxide in the presence of water at room temperatures or with heat to form calcium silicates hydrates (CSH) and calcium aluminates hydrates (CAH), to form cements. As used herein, the term “alkali-silica reaction,” and grammatical variations thereof, refers to the reaction of various forms of silica with alkali. As used herein, the term “alkali-carbonate reaction,” and grammatical variations thereof, refers to the reaction of certain dolomitic materials with alkali. In various embodiments, a set retarding agent of the present disclosure can prevent or delay and/or slow a polymerization reaction of an un-activated UF composition (e.g., a pozzolanic reaction) and/or of an activated UF composition (e.g., a geopolymerization reaction) of the present disclosure, thus allowing control of formation of the solidified UF composition described herein.

As used herein, the term “fluid loss control agent,” and grammatical variants thereof, refers to a substance that lowers the volume of filtrate that passes through a filter medium. In particular, the fluid loss control agent controls the loss of fluid to a subterranean formation through filtration, including during drilling and/or cementing operations. Unless otherwise indicated, fluid loss of a UF composition of the present disclosure is determined according to API 13B-1 (2023) (at 250° F., a differential pressure of 500 psi, where prior to testing, samples are heat rolled at 160° F. (71.1° C.) for 16 hours). An acceptable HDHP fluid loss volume for a drilling mud according to the HTHP fluid loss test is less than 10 milliliters (mL) per 30 minutes (min). For preventing fluid loss, the best drilling muds should form filter cakes that are thin and impermeable. An ideal thickness for a filter cake is up to 4/32 inches.

As used herein, the term “viscosifier,” and grammatical variants thereof, refers to a substance that can increase the viscosity of the flowable UF compositions of the present disclosure. Viscosifiers thus represent a class of rheology modifiers and may be alternatively referred to in the industry as “thickeners” or “thickening agents.”

As used herein, the terms “plastic viscosity” or “PV,” and grammatical variants thereof, refer to a rheology property related to the resistance of a fluid (i.e., the flowable UF compositions of the present disclosure) to flow due to mechanical interaction between solids therein. The PV is expressed in centipoise (cP) and may be calculated by measuring the shear stress of the fluid using a rheometer at spindle speeds of 300 rotations per minute (rpm) and 600 rpm and subtracting the 300 rpm dial reading from the 600 rpm dial reading according to the Equation (I):

PV=(Dial Reading at 600 rpm)−(Dial Reading at 300 rpm).

As used herein, the terms “yield point” or “YP,” and grammatical variants thereof, refer to a rheology property related to the value obtained from the Bingham-Plastic rheological model when extrapolated to a shear rate of zero. The YP is expressed as force per area, such as foot-pounds per 100 square feet (lbf/100 ft²) and may be calculated using 300 rpm and 600 rpm shear rate readings and the PV value (expressed in Equation (I)) according to the Equation (II):

YP=(Dial Reading at 300 rpm)−PV.

As used herein, the terms “low shear yield point” or “LSYP,” and grammatical variants thereof, refer to a rheology property related to an estimate of the yield stress at the lowest shear stress value above which a material will behave like a fluid and below which the material will behave like a solid. LSYP is expressed as force per area, such as lbf/100 ft², and may be calculated by measuring the shear stress of the aqueous-based carrier fluid using a rheometer at spindle speeds of 3 rotations per minute (rpm) and 6 rpm according to Equation (III): LSYP=[2*(Dial Reading at 3 rpm)]−(Dial Reading at 6 rpm)]. Unless otherwise indicated, the rheology properties (PV, YP, LSYP) of the UF compositions of the present disclosure are measured according to API 13B-1 (2023) (at 120° F. (48.9° C.), where prior to testing, samples are heat rolled at 160° F. (71.1° C.) for 16 hours).

As used herein, the term “thickening time,” and grammatical variants thereof, refers to the duration of time that a flowable UF composition of the present disclosure remains in a fluid state and is capable of being pumped. The thickening time may be assessed under downhole conditions using a pressurized consistometer that plots the viscosity of a slurry over time under the anticipated temperature and pressure conditions. In various embodiments, thickening time is the time to the point at which flowable UF compositions reach a set Bearden consistency (e.g., 70 Bearden consistency units (70 Bc), 90 Bc, or 100 Bc) at a target temperature, e.g. 250° F. In certain embodiments, the thickening time is measured according to API RP 10B-2 (2019). As used herein, the term “solidified UF composition,” and grammatical variants thereof, refer to the final solid-phase (i.e., a rigid solid) that forms after a flowable UF composition of the present disclosure has been activated and after completion of geopolymerization of the aluminosilicate material therein.

As used herein, the term “compressive strength,” and grammatical variants thereof, refers to a mechanical property of the solidified UF compositions of the present disclosure related to the capacity of a solidified UF composition specimen to withstand axially directed pushing forces. Unless otherwise indicated, the compressive strength of the solidified UF compositions of the present disclosure is measured according to API RP 10B-2 (2019).

### Flowable Universal Fluid Compositions

The flowable UF compositions of the present disclosure may be formulated such that desired rheological and fluid loss control properties are achieved during drilling operations and desired mechanical properties are achieved during cementing operations within a wellbore in a subterranean formation. Generally, but not always, the primary components of the flowable UF compositions are pre-mixed prior to use in a drilling and/or cementing operation. During drilling operations, the flowable UF composition may be a flowable fluid, while, during cementing operations, contact of the flowable UF composition with an alkaline activator and heat may transform the flowable UF composition into the solidified UF composition.

It is to be appreciated that while the present disclosure discusses the use of the flowable UF compositions of the present disclosure during subterranean formation wellbore drilling and cementing operations, other subterranean formation operations may additionally employ the flowable UF compositions described herein, without departing from the scope of the present disclosure. Such operations may include, but are not limited to, completion operations, stimulation operations (e.g., fracturing operations), enhanced oil recovery operations (e.g., conformance control), and the like, and any combination thereof.

In general, the flowable UF compositions of the present disclosure may comprise primary components of at least an aqueous-based carrier fluid, one or more aluminosilicate materials, one or more set retarding agents, one or more viscosifiers, and one or more fluid loss control agents. In various embodiments, the flowable UF compositions may further include one or more salts, one or more pH control agents, the like, or any combination thereof. Additional additives also may be included in the flowable UF compositions of the present disclosure, such as those listed herein below. However, as described herein, flowable UF compositions of the present disclosure require one or more alkaline activators to trigger a geopolymerization reaction used to convert the flowable UF composition from a flowable fluid (for drilling a wellbore) into a solidified UF composition (for forming a cement sheath). The activator type, activator quantity, and timing of activator addition is useful to control the timing of the transition from fluid to solid.

The aqueous-based carrier fluid may include, but is not limited to, freshwater, acidified water, salt water, seawater, brine (e.g., a saturated salt solution), or an aqueous salt solution (e.g., a non-saturated salt solution), purified wastewater, deionized water, and any combination thereof. The aqueous-based carrier fluid of the present disclosure may be used to dissolve or otherwise suspend components of the flowable UF compositions described herein into a wellbore during a drilling and/or cementing operation. In one or more instances, the aqueous carrier fluid is “slick water,” having a low viscosity of generally less than about 100 cP, such as in the range of about 1 cP to about 50 cP, encompassing any value and subset therebetween, such as in the range of about 1 cP to about 10 cP, from about 10 cP to about 20 cP, from about 20 cP to about 30 cP, from about 30 cP to about 40 cP, from about 40 cP to about 50 cP, from about 10 cP to about 30 cP, from about 15 cP to about 35 cP.

The aluminosilicate materials of the present disclosure are the primary components of the flowable UF compositions and impart, at least, desired curing profile time, rheology properties (e.g., viscosity, yield strength), and mechanical properties (e.g., compressive strength). Aluminosilicate materials may be natural or synthetic. Examples of suitable natural and synthetic aluminosilicate materials include, but are not limited to, fly ash (e.g., siliceous fly ash, calcareous fly ash), slag (e.g., blast furnace slag), natural or synthetic pozzolan, volcanic ash (e.g., Saudi Arabian volcanic ash), silica fume, silica sand, silica flour, quartz, limestone, kaolinite, metakaolin, Red Mud, and the like, and any combination thereof. The aluminosilicate materials may comprise silicon oxides (e.g., SiO₂), silicates, aluminum oxides (e.g., Al₂O₃), aluminates, aluminum silicates, calcium oxides (e.g., CaO), calcium hydroxide, calcium silicates (e.g., alite (Ca₃SiO₅), belite (Ca₂SiO₄)), calcium aluminates (e.g., tricalcium aluminate (Ca₃Al₂O₆), tetracalcium aluminoferrite (Ca₄Al₂Fe₂O₁₀), brownmilleriate (4CaO·Al₂O₃·Fe₂O₃), calcium aluminates), iron oxides (e.g., Fe₂O₃), titanium oxides (e.g., TiO₂), magnesium oxides (e.g., MgO), strontium oxides (e.g., SrO), potassium oxides (e.g., K₂O), sulfur oxides (e.g., SO₃), barium oxides (e.g., BaO), manganese oxides (e.g., MnO, Mn₃O₄), gypsum (CaSO₄·2H₂O), hexavalent chromium, trivalent chromium, hematite, and the like, and any combination thereof.

In various embodiments, aluminosilicate materials may comprise natural or synthetic aluminosilicate materials. Aluminosilicate materials may comprise the equivalent of up to about 50 weight percent (wt %), on a total SiO₂ and Al₂O₃ basis, including all wt. % values and subranges therebetween, based on the total weight of the aluminosilicate materials (e.g., from 10 wt % to about 50 wt %, from about 20 wt % to about 50 wt %, or from 30 wt % to about 50 wt %, or from about 40 wt % to about 50 wt %). In various embodiments, aluminosilicate materials may comprise up to about 40 wt %, on a total SiO₂ and Al₂O₃ basis, based on the total weight of the aluminosilicate materials. In various embodiments, an aluminosilicate material may comprise an SiO₂/Al₂O₃ molar ratio of from about 0.5 to about 10, including all molar ratio values and subsets therebetween (e.g., from about 1 to about 8, or from about 2 to about 4).

In various embodiments, aluminosilicate materials may comprise calcium oxide (CaO) at about 50 wt % or less, including all wt % values and subsets therebetween, based on the total weight of the aluminosilicate materials (e.g., about 45 wt % or less, about 30 wt % or less, about 25 wt % or less, or from about 20 wt % to about 40 wt %). In various embodiments, aluminosilicate materials may comprise calcium oxide (CaO) at about 20 wt % to about 40 wt %, based on the total weight of the aluminosilicate materials. In various embodiments, aluminosilicate materials may be synthetic aluminosilicate materials (e.g., prepared by a sol-gel process, or the like) with a Si/Al molar ratio similar to any natural aluminosilicate of the present disclosure, but without other oxides found in said natural aluminosilicate (such as Fe₂O₃, CaO, MgO, K₂O, TiO₂, the like, or any combination thereof).

Aluminosilicate materials may be included in the flowable UF compositions of the present disclosure at from about 30 weight percent (wt %) to about 75 wt %, including all wt % values and subsets therebetween, based on the total weight of the flowable UF compositions (e.g., from about 30 wt % to about 35 wt %, from about 35 wt % to about 40 wt %, from about 40 wt % to about 45 wt %, from about 45 wt % to about 50 wt %, from about 50 wt % to about 55 wt %, from about 55 wt % to about 60 wt %, from about 60 wt % to about 65 wt %, from about 65 wt % to about 70 wt %, from about 70 wt % to about 75 wt %, from about 40 wt % to about 60 wt %, from about 45 wt % to about 65 wt %, or from about 55 wt % to about 75 wt %). In various embodiments, aluminosilicate materials are present in the flowable UF compositions at from about 45 wt % to about 65 wt %, based on the total weight of the flowable UF compositions.

In various embodiments, the flowable UF compositions of the present disclosure exclude any geopolymer cement precursor materials other than aluminosilicate materials of the present disclosure. In various embodiments, in addition to aluminosilicate materials, the flowable UF compositions of the present disclosure further include one or more other geopolymer cement precursor materials and/or traditional (e.g., Portland cement) precursors. The additional cement precursor materials may be hydraulic or non-hydraulic. A hydraulic cement precursor material refers to a mixture of limestone, clay, and gypsum burned together under temperatures greater than 1000° C. that may begin to cure (harden) relatively quickly (i.e., while in contact with water). Examples of suitable hydraulic cement precursors may include, but are not limited to, Portland cement, the like, and any combination thereof. A non-hydraulic cement precursor material refers to a mixture of lime, gypsum, plasters, and oxychloride that generally takes comparatively longer to cure (harden) and/or may require certain drying conditions, such as heat and time. The selection of a hydraulic cement precursor or non-hydraulic cement precursor may thus depend on the parameters of the particular wellbore to be drilled, such as depth, length, and trajectory to ensure that the time prior to the curing of a flowable UF composition is sufficient to complete desired drilling operations.

Fluid loss control agents may be included in the flowable UF compositions described herein to prevent or reduce fluid loss during drilling and/or cementing operations under formation temperature conditions. Fluid loss control agents, in various embodiments, may further act as a viscosifier, depending upon the selected fluid loss control agents. In various embodiments, the surface charge of aluminosilicate materials is matched with the charge of the high temperature-stable fluid loss control agent, e.g., by matching particles with a neutral surface charge with neutral polymers, by matching particles with an anionic surface charge with anionic or neutral polymers, or the like.

In various embodiments, fluid loss control agents may comprise polymer fluid loss control agents. Suitable examples of polymer fluid loss control agents may include, but are not limited to, modified starch polymers, styrene butadiene polymers, and any combination thereof. As used herein, “modified starch polymer,” and grammatical variations thereof, refers to starches modified with etherification, esterification, oxidation, or cationization. In various embodiments, modified starch polymers may comprise at least one component selected from the group comprising nonionic modified starch polymers, anionic modified starch polymers, salts thereof, the like, and any combination thereof. In various embodiments, nonionic starch polymers may comprise at least one component selected from the group consisting of ester substituted starch polymers, the like, and any combination thereof. In various embodiments, anionic starch polymers comprise at least one component selected from the group comprising phosphorylated starch polymers, oxidized starch polymers, carboxymethylated starch polymers, the like, and any combination thereof. Examples of suitable nonionic modified starch polymers include ExStar® HT (Chemstar), RheoStar® D (Chemstar), the like, and any combination thereof. Examples of suitable anionic modified starch polymers include StarPak® II (Chemstar), StarPak® Extreme (Chemstar), the like, and any combination thereof.

In various embodiments, styrene butadiene polymers may be selected from the group consisting of styrene butadiene biopolymers, synthetic styrene butadiene polymers, the like, or any combination thereof. In various embodiments, styrene-butadiene polymers may be copolymers, terpolymers, the like, or any combination thereof, each comprising at least styrene and butadiene repeat units. In various embodiments, styrene-butadiene polymers may be selected from the group consisting of styrene-butadiene-styrene (SBS) block copolymers, the like, and any combination thereof. Examples of suitable styrene butadiene polymers include, but are not limited to, styrene-butadiene copolymers (e.g., PEXOSEAL™ series (Synthomer), BASOBLOCK D623 (BASF)), styrene-butadiene terpolymers (e.g., biocopolymer styrene-butadiene terpolymer XD5043PD (OMNOVA)), and the like.

In various embodiments, when the aluminosilicate materials comprise fly ash, fluid loss control agents may comprise at least one component selected from nonionic fluid loss control agents, anionic fluid loss control agents, salts thereof, the like, and any combination thereof (e.g., nonionic or anionic modified starch polymers, nonionic or anionic styrene butadiene polymers, the like, and any combination thereof). In various embodiments, when aluminosilicate materials comprise slag, the fluid loss control agents may comprise at least one component selected from the group consisting of nonionic fluid loss control agents (e.g., nonionic modified starch polymers, nonionic styrene butadiene polymers, the like, and any combination thereof).

Fluid loss control agents may be included in the flowable UF compositions of the present disclosure at from about 0.05 wt % to about 10 wt %, encompassing any value and subset therebetween, based on the total weight of the flowable UF composition (e.g., from about 0.05 wt % to about 0.1 wt %, from about 0.1 wt % to about 0.25 wt %, from about 0.1 wt % to about 5 wt %, from about 0.25 wt % to about 0.5 wt %, from about 0.5 wt % to about 1 wt %, from about 1 wt % to about 2 wt %, from about 2 wt % to about 3 wt %, from about 3 wt % to about 4 wt %, from about 4 wt % to about 5 wt %, from about 5 wt % to about 6 wt %, from about 6 wt % to about 7 wt %, from about 7 wt % to about 8 wt %, from about 8 wt % to about 9 wt %, from about 9 wt % to about 10 wt %, from about 2 wt % to about 4 wt %, or from about 3 wt % to about 4 wt %). In various embodiments, the fluid loss control agents are present in flowable UF compositions at from about 0.5 wt % to about 1 wt %, based on the total weight of the flowable UF composition.

In various embodiments, flowable UF compositions of the present disclosure exhibit: an HTHP fluid loss volume of from about 10 milliliters (mL) to about 50 mL, including all mL values and ranges therebetween (e.g., from about 10 mL to about 25 mL) as measured by API 13B-1 (2023) as described herein. In various embodiments, flowable UF compositions of the present disclosure exhibit: an HTHP filter cake thickness of from 5/32″ to 1″, including all inch (″) values and subranges therebetween (e.g., from about 5/32″ to about 15/32″), as measured by API 13B-1 (2023) as described herein.

Viscosifiers may be included in the flowable UF compositions to influence viscosity as the flowable UF compositions is circulated within a subterranean formation during a drilling and/or cementing operation. The viscosity may affect, for example, the pumpability of the flowable UF compositions, including pump rate and equipment requirements. The viscosity of the flowable UF compositions represents its resistance to flow, defined as the ratio of shear stress to shear rate.

Viscosifiers for use in the flowable UF compositions of the present disclosure may include, but are not limited to, natural and derivatized polysaccharides, polyacrylamide and its derivatives, bentonites, salts thereof, the like, that are soluble, dispersible or swellable in the flowable UF compositions (i.e., in the aqueous-based carrier fluid thereof) to impart or increase viscosity. Suitable examples of polysaccharide viscosifiers may include, but are not limited to, natural and derivatized gums, natural and derivatized celluloses, and the like, and any combination thereof. Suitable examples of polyacrylamide viscosifiers may include, but are not limited to, anionic water-soluble acrylamide co-polymers, partially hydrolyzed polyacrylamide (PHPA), salts thereof, or the like, e.g., Hyperdrill™ series (SNF) polyacrylamide viscosifiers, including, but not limited to, Hyperdrill™ DP/AF 8202 XP. In various embodiments, flowable UF compositions of the present disclosure may consist of polyacrylamides, derivatives thereof, salts thereof, and any combination thereof.

Viscosifiers may be included in the flowable UF compositions of the present disclosure at from about 0.05 wt % to about 1 wt %, including all wt % values and subsets therebetween, based on the total weight of the flowable UF composition (e.g., from about 0.05 wt % to about 0.1 wt %, from about 0.1 wt % to about 0.2 wt %, from about 0.2 wt % to about 0.3 wt %, from about 0.3 wt % to about 0.4 wt %, from about 0.4 wt % to about 0.5 wt %, from about 0.5 wt % to about 0.6 wt %, from about 0.6 wt % to about 0.7 wt %, from about 0.7 wt % to about 0.8 wt %, from about 0.8 wt % to about 0.9 wt %, from about 0.9 wt % to about 1 wt %, from about 0.5 wt % to about 1 wt %, from about 0.05 wt % to about 0.1 wt %, or from about 0.1 wt % to about 0.5 wt %). In various embodiments, viscosifiers may be present in flowable UF compositions at from about 0.1 wt % to about 0.5 wt %, based on the total weight of the flowable UF compositions.

The thickening and solidification time of flowable UF compositions of the present disclosure may be designed to be sufficiently long to enable performance of drilling operations, where the flowable UF compositions remain in a flowable fluid state until drilling of a wellbore is complete. Flowable UF compositions of the present disclosure may further be designed to become activated, and to thicken and solidify over a sufficient time for use as part of a cementing operation to form a cement sheath in a wellbore. The thickening and solidification time of flowable UF compositions of the present disclosure may be influenced or otherwise delayed with one or more set retarding agents comprised therein. In various embodiments, set retarders may delay setting of aluminosilicates by inhibiting hydration thereof. Examples of suitable set retarding agents for use in forming the UF compositions of the present disclosure may include, but are not limited to, organic retarders (lignosulfonates, hydroxycarboxylic acids and their salts, phosphonates, sugars) and inorganic retarders (phosphonates, borates etc.). Specific suitable set retarding agents may include, but are not limited to, lignosulfonates (e.g., sodium lignosulfonates, calcium lignosulfonates, and the like, such as BioDrill® RC series lignosulfonates (Borregaard), including, but not limited to, BioDrill® RC502 (a calcium lignosulfonate)) sodium borate, zinc borate, boric acid, sodium tartrate, sodium citrate, sodium gluconate, sodium itaconate, tartaric acid, citric acid, gluconic acid, itaconic acid, and the like, and any combination thereof. These set retarding agents may further be suitable for inhibiting/delaying geopolymerization reactions, pozzolanic reactions, and various other hydration reactions which may occur within flowable UF compositions. In various embodiments, set retarders of the present disclosure may consist of lignosulfonates, the like, and any combination thereof.

One or more set retarding agents may be included in the flowable UF compositions of the present disclosure at from about 0.05 wt % to about 5 wt %, encompassing any value and subset therebetween, based on the total weight of the flowable UF compositions (e.g., from about 0.05 wt % to about 0.1 wt %, from about 0.1 wt % to about 0.25 wt %, from about 0.25 wt % to about 0.5 wt %, from about 0.5 wt % to about 0.75 wt %, from about 0.75 wt % to about 1 wt %, from about 1 wt % to about 2 wt %, from about 2 wt % to about 3 wt %, from about 3 wt % to about 4 wt %, from about 4 wt % to about 5 wt %, from about 0.1 wt % to about 0.5 wt %, from about 0.5 wt % to about 1.5 wt %, from about 1.5 wt % to about from about 3 wt %, from about 2 to about 4.5 wt %, from about 2.5 wt % to about 5 wt %). In various embodiments, set retarding agents may be present in flowable UF compositions at from about 0.5 wt % to about 1.5 wt %, based on the total weight of the flowable UF compositions.

Flowable UF compositions of the present disclosure may comprise one or more additional additives. Suitable additives include, but are not limited to, salts, pH adjusters, the like, and any combination thereof. Suitable salts include, but are not limited to, sodium chloride, calcium chloride, magnesium chloride, sodium sulfate, sodium carbonate, sodium bicarbonate, the like, and any combination thereof. Salts may be present in flowable UF compositions at from about 1 wt % to about 10 wt %, including all wt % values and subsets therebetween, based on the total weight of the flowable UF composition (e.g., from about 1 wt % to about 2 wt %, from about 2 wt % to about 3 wt %, from about 3 wt % to about 4 wt %, from about 4 wt % to about 5 wt %, from about 5 wt % to about 6 wt %, from about 6 wt % to about 7 wt %, from about 7 wt % to about 8 wt %, from about 8 wt % to about 9 wt %, from about 9 wt % to about 10 wt %, from about 1 wt % to about 3 wt %, from about 2 wt % to about 4 wt %, from about 2.5 wt % to about 4.5 wt %, from about 3 wt % to about 5 wt %, from about 4 wt % to about 6 wt %, from about 5 wt % to about 7 wt %, from about 6 wt % to about 8 wt %, from about 7 wt % to about 9 wt %, or from about 8 wt % to about 10 wt %). In various embodiments, salts may be present in the flowable UF compositions at from about 2.5 wt % to about 4.5 wt %, based on the total weight of the flowable UF compositions.

Suitable pH adjusters may include, but are not limited to sodium carbonate, sodium bicarbonate, the like, and any combination thereof. Suitable pH adjusters which keep flowable UF compositions below a pH of about 12 are also suitable as set retarders, while pH adjusters which increase the pH of UF compositions to about 12 are also suitable as set accelerators. Suitable pH adjusters may be present in flowable UF compositions at from about 0.05 wt % to about 1 wt %, including all wt % values and subsets therebetween, based on the total weight of the flowable UF composition (e.g., from about 0.05 wt % to about 0.1 wt %, from about 0.1 wt % to about 0.2 wt %, from about 0.2 wt % to about 0.3 wt %, from about 0.3 wt % to about 0.4 wt %, from about 0.4 wt % to about 0.5 wt %, from about 0.5 wt % to about 0.6 wt %, from about 0.6 wt % to about 0.7 wt %, from about 0.7 wt % to about 0.8 wt %, from about 0.8 wt % to about 0.9 wt %, from about 0.9 wt % to about 1 wt %, from about 0.5 wt % to about 1 wt %, from about 0.05 wt % to about 0.1 wt %, or from about 0.1 wt % to about 0.5 wt %). In various embodiments, pH adjusters may be present in flowable UF compositions at from about 0.1 wt % to about 0.5 wt %, based on the total weight of the flowable UF compositions.

The rheological properties of the flowable UF compositions described herein may be determined by measuring the shear stress on the flowable UF compositions at different shear rates. The various shear rates are utilized because aqueous-based flowable UF compositions can behave as a rigid body at lesser shear stresses but flow as a viscous fluid at greater shear stresses. The rheology of the flowable UF compositions may be characterized by its PV, YP, and LSYP, as defined above.

The PV is related to the resistance of the flowable UF compositions to flow due to mechanical interaction between solids, such as fines, entrained within the flowable UF compositions during drilling operations. The PV represents the viscosity of the flowable UF compositions extrapolated to infinite shear rate. PV may be increased by viscous base fluids and excess colloidal solids.

In some embodiments, the flowable UF compositions of the present disclosure may have a PV at 120° F. in the range of about 25 centipoise (cP) to about 100 cP, encompassing any value and subset therebetween, such as from about 25 cP to about 50 cP, from about 50 cP to about 75 cP, from about 75 cP to about 100 cP, from about 50 cP to about 100 cP, from about 25 cP to about 75 cP, from about 40 cP to about 80 cP, from about 35 cP to about 75 cP. In some instances, the flowable UF composition has a PV at 120° F. in the range of about 8 cP to about 35 cP.

The flowable UF compositions of the present disclosure may behave as a rigid body when the shear stress is less than the YP and may flow as a fluid when the shear stress is greater than the YP. That is, the yield point represents the amount of stress required to move the drilling fluid from a static condition. Yield point provides an indication of the ability of the flowable UF compositions to carry solids, such as rock cuttings, during drilling operations, through the annulus, which, in simplified terms, gives an indication of the ability of a flowable UF composition to lift cuttings away from the bottom of a wellbore in a subterranean formation. As an example, a drilling or completion fluid for primary well control having a YP of equal to or greater than 15 lbf/100 ft² is considered acceptable for drilling a wellbore.

In one or more aspects of the present disclosure, the flowable UF compositions of the present disclosure may have a YP at 120° F. in the range of about 15 foot-pounds per 100 square feet (lbf/100 ft²) to about 75 lbf/100 ft², encompassing any value and subset therebetween, such as from about 15 lbf/100 ft² to about 25 lbf/100 ft², from about 15 lbf/100 ft² to about 50 lbf/100 ft², from about 25 lbf/100 ft² to about 35 lbf/100 ft², from about 35 lbf/100 ft² to about 45 lbf/100 ft², from about 45 lbf/100 ft² to about 55 lbf/100 ft², from about 55 lbf/100 ft² to about 65 lbf/100 ft², from about 65 lbf/100 ft² to about 75 lbf/100 ft², from about 20 lbf/100 ft² to about 75 lbf/100 ft², from about 25 lbf/100 ft² to about 75 lbf/100 ft², from about 25 lbf/100 ft² to about 70 lbf/100 ft². In some embodiments, the flowable UF compositions of the present disclosure may have a YP at 120° F. from about 15 lbf/100 ft² to about 25 lbf/100 ft².

The LSYP of the flowable UF compositions of the present disclosure plays a significant role in wellbore cleaning and the carrying capacity of the flowable UF compositions.

Generally, improved rheology is obtained with lower LSYP values. In one or more aspects of the present disclosure, the LSYP of the flowable UF compositions at 120° F. may be from about 1 lbf/100 ft² to about 20 lbf/100 ft², encompassing any value and subset therebetween, such as from about 1 lbf/100 ft² to about 10 lbf/100 ft², from about 1 lbf/100 ft² to about 4 lbf/100 ft², from about 4 lbf/100 ft² to about 6 lbf/100 ft², from about 6 lbf/100 ft² to about 8 lbf/100 ft², from about 8 lbf/100 ft² to about 10 lbf/100 ft², from about 10 lbf/100 ft² to about 12 lbf/100 ft², from about 12 lbf/100 ft² to about 14 lbf/100 ft², from about 14 lbf/100 ft² to about 16 lbf/100 ft², from about 5 lbf/100 ft² to about 15 lbf/100 ft², from about 5 lbf/100 ft² to about 10 lbf/100 ft², from about 4 lbf/100 ft² to about 10 lbf/100 ft². In some embodiments, the flowable UF compositions of the present disclosure may have an LSYP at 120° F. of from about 7 lbf/100 ft² to about 15 lbf/100 ft².

As stated above, the flowable UF compositions of the present disclosure require an activator to thicken and solidify the aluminosilicate materials therein into solidified UF compositions. The type of activator, the quantity of the activator, the weight ratio of the set retarding agent and the activator, and the timing of addition of the activator may be used to control the timing of the transition from fluid-phase to thickened-phase to solidified-phase, without departing from the scope of the present disclosure. The activator for initiating a geopolymerization of the aluminosilicate materials within the flowable UF compositions of the present disclosure may be an alkaline activator. Examples of suitable alkaline activators may include, but are not limited to, sodium hydroxide, sodium silicate, potassium silicate, potassium hydroxide, sodium carbonate, sodium sulfate, calcium oxide, calcium hydroxide, and the like, and any combination thereof. Suitable activators for geopolymerization reactions may also be suitable activators for other reactions, e.g., pozzolanic reactions, and the like. The alkaline activator may be contacted with the flowable UF compositions of the present disclosure at from about 1 wt % to about 20 wt %, active alkali, based on the total weight of the aluminosilicate material, encompassing any value and subset therebetween (e.g., from about 5 wt % to about 10 wt %, from about 5 wt % to about 15 wt %, from about 5 wt. % to about 20 wt %, from about 10 wt % to about 15 wt %, from about 10 wt % to about 20 wt %, or from about 15 wt % to about 20 wt %). The alkaline activator may be contacted with the flowable UF compositions of the present disclosure at from about 5 wt % to about 20 wt %, active alkali, based on the total weight of the aluminosilicate material.

At formation conditions, e.g., at formation temperature conditions, the alkaline activator may initiate thickening of an activated flowable UF composition. The particular thickening time period may depend on a number of factors and can be tuned accordingly, such as based on the formation temperature and/or pressure conditions, the concentration of retarding agent, the like, and any combination thereof. Typically, a greater formation temperature will reduce thickening time. Formation conditions e.g., formation temperature conditions, may result in a thickening time period (e.g., a 70 Bearden consistency unit (70 Bc) thickening time, or a 90 Bc thickening time, or the like) of the activated flowable UF compositions of the present disclosure of from about 1 hour to about 30 hours, encompassing any value and subset therebetween (such as from about 1 hour to about 5 hours, from about 5 hours to about 10 hours, from about 10 hours to about 15 hours, from about 15 hours to about 20 hours, about 20 hours to about 28 hours, about 2 hours to about 10 hours, from about 10 hours to about 28 hours). In various embodiments, activation of a flowable UF composition at a temperature of 250° F. with an alkaline activator at from 5 weight percent (wt %) to 20 wt %, based on the total weight of the aluminosilicate material, will result in an activated flowable UF composition exhibiting a 70 Bearden consistency unit (70 Bc) thickening time of from one hour to three hours.

As described above, activated flowable UF compositions may first thicken, and eventually solidify into solid UF compositions of the present disclosure (i.e., for cementing purposes). Moreover, solid UF compositions of the present disclosure may effectively address fluid loss zones ranging from minor fluid loss (seepage-loss) to complete fluid loss (severe loss). Solidification of the flowable UF compositions may occur under formation conditions, e.g., formation temperature conditions. The particular solidification time period may depend on a number of factors and can be tuned accordingly, such as based on the formation temperature and/or pressure conditions, the concentration of retarding agent, the like, and any combination thereof. Typically, a greater formation temperature will reduce solidification time. The solidification time period for forming the solidified UF compositions from the flowable UF compositions under formation conditions may be from about 0 days to about 70 days, encompassing any value and subset therebetween, such as from about 24 hours to about 30 days, including all time values and subsets therebetween (e.g., from about 24 hours to about 7 days, from about 7 days to about 2 weeks, or from about 2 weeks to about 3 weeks).

The compressive strength of the solid UF compositions of the present disclosure is a function of both cement maturity (i.e., time since solidification) and the formation temperature and/or pressure conditions. In one or more aspects, the compressive strength of the solid UF compositions may be from about 100 psi to about 15,000 psi, encompassing any value and subset therebetween, such as from about 100 psi to about 1,500 psi, from about 1,500 psi to about 3,000 psi, from about 3,000 psi to about 4,500 psi, from about 4,500 psi to about 6,000 psi, from about 6,000 psi to about 7,500 psi, from about 7,500 psi to about 9,000 psi, from about 9,000 psi to about 10,500 psi, from about 10,500 psi to about 12,000 psi, from about 12,000 psi to about 13,500 psi, from about 13,500 psi to about 15,000 psi, from about 250 psi to about 12,000 psi, from about 500 psi to about 10,000 psi. In various embodiments, after solidification of an activated UF composition (e.g., a flowable UF composition contacted at a temperature of 250° F. with an alkaline activator at from 5 weight percent (wt %) to 20 wt %, based on the total weight of the aluminosilicate material), the solidified UF composition exhibits a compressive strength of from 100 pounds per square inch (psi) to 15,000 pounds psi after from 24 hours to 30 days.

Accordingly, the flowable UF compositions of the present disclosure may exhibit suitable thickening and solidification time periods under formation temperature and/or pressure conditions, as described herein, to perform first as a flowable wellbore drilling fluid, and, upon activation, as a rigid, strong cement sheath in the drilled wellbore. The flowable UF compositions of the present disclosure further comprise fluid loss control agents that can effectively address fluid loss zones ranging from minor fluid loss (seepage-loss) to complete fluid loss (severe loss) under such formation temperature conditions.

### Methods of Use of Universal Fluids for Drilling and Cementing

In an aspect, a flowable UF composition of the present disclosure may be provided to and used in a drilling operation to form a wellbore in a subterranean formation and for use in a subsequent cementing operation and, additionally, for fluid loss control. In one or more embodiments, the components of the flowable UF composition may be pre-mixed to form the flowable UF composition prior to use in the drilling operation.

In various embodiments, the fluid loss control agent of the flowable UF composition may prevent or reduce loss of the flowable UF composition to one or more fluid loss zones in the subterranean formation. In various embodiments, at least a portion of the flowable UF composition may remain within the wellbore upon completing the drilling, i.e., in the annular area between a casing and the surrounding formation. One or more alkaline activators may be introduced into the wellbore during or after completing the drilling operation. Upon contact with the alkaline activator, the flowable UF composition remaining within the subterranean formation (i.e., within the annular space and optionally within one or more fluid loss zones) may be activated, and at formation temperature conditions, the activated flowable UF composition may solidify to form a solidified UF composition as described herein. Moreover, conversion of the flowable UF compositions into the solid UF compositions of the present disclosure may effectively address any fluid loss ranging from minor fluid loss (seepage-loss) to complete fluid loss (severe loss).

Accordingly, embodiments in accordance with the present disclosure include the use of a UF composition during drilling and cementing operations. As described above, other subterranean formation operations requiring lost circulation control are also applicable to the embodiments of the present disclosure.

Embodiments disclosed herein include:

Embodiment A: A flowable universal fluid (UF) composition comprising: a mixture of: an aqueous-based carrier fluid; an aluminosilicate material; a set retarding agent; a polyacrylamide viscosifier; and a fluid loss control agent; wherein the flowable UF composition exhibits: a HTHP fluid loss volume of from 10 milliliters (mL) to 50 mL; and/or a HTHP filter cake thickness of from 5/32″ to 1″, as measured by API 13B-1 (2023); and wherein, upon contact with an alkaline activator, the activated flowable UF composition is capable of solidifying under formation temperature conditions, thereby forming a solidified UF composition.

Embodiment B: A method comprising: providing a flowable universal fluid (UF) comprising: a mixture of: an aqueous-based carrier fluid; an aluminosilicate material; a set retarding agent; a polyacrylamide viscosifier; and a fluid loss control agent, wherein the flowable UF composition exhibits: a HTHP fluid loss volume of from 10 milliliters (mL) to 50 mL; and/or a HTHP filter cake thickness of from 5/32″ to 1″, as measured by API 13B-1 (2023); drilling a wellbore in a subterranean formation using the flowable UF composition, wherein at least a portion of the flowable UF composition remains in the wellbore upon completion of the drilling; introducing an alkaline activator into the wellbore, thereby contacting the remaining flowable UF composition therein with the alkaline activator; and allowing the activated flowable UF composition in the wellbore to solidify under formation temperature conditions, thereby forming a solidified UF composition in the wellbore.

Each of embodiments A and B may have one or more of the following additional elements in any combination:

Element 1: wherein the flowable UF composition exhibits: a HTHP fluid loss volume of from 10 milliliters (mL) to 25 mL; and/or a filter cake thickness of from 5/32″ to 15/32″, as measured by API 13B-1 (2023).

Element 2: wherein the aluminosilicate material comprises at least one component selected from the group consisting of fly ash, slag, and any combination thereof.

Element 3: wherein the fluid loss control agent comprises at least one component selected from the group consisting of modified starch polymers, styrene butadiene polymers, salts thereof, and any combination thereof; and/or wherein the fluid loss control agent comprises at least one component selected from the group consisting of nonionic fluid loss control agents, anionic fluid loss control agents, salts thereof, and any combination thereof.

Element 4: wherein, when the aluminosilicate material comprises slag, the fluid loss control agent comprises at least one component selected from the group consisting of nonionic modified starch polymers, nonionic styrene butadiene polymers, and any combination thereof.

Element 5: wherein the polyacrylamide viscosifier comprises at least one component selected from the group consisting of anionic polyacrylamides, partially hydrolyzed polyacrylamides, salts thereof.

Element 6: wherein the UF composition comprises: the aluminosilicate material at from 40 weight % (wt %) to 60 wt %; the set retarding agent at from 0.5 wt % to 1.5 wt %; the polyacrylamide viscosifier at from 0.1 wt % to 0.5 wt %; and/or the fluid loss control agent at from 0.5 wt % to 1 wt %.

Element 7: wherein the flowable UF composition comprises at least one component selected from the group consisting of a salt, a pH adjuster, and any combination thereof.

Element 8: wherein the flowable UF composition exhibits: a plastic viscosity at 120° F. of from 25 centipoise (cP) to 50 cP; a yield point at 120° F. of from 15 foot-pounds per 100 square feet (lbf/100 ft²) to 40 lbf/100 ft²; and/or a low shear yield point at 120° F. of from 1 lbf/100 ft² to 6 lbf/100 f², as measured by API 13B-1 (2023).

Element 9: wherein, upon contact at 250° F. of the flowable UF composition with an alkaline activator at from 5 weight percent (wt %) to 20 wt %, based on the total weight of the aluminosilicate material: the flowable UF composition exhibits a 70 Bearden consistency unit (70 Bc) thickening time of from one hour to three hours; and/or the solidified UF composition exhibits a compressive strength of from 100 pounds per square inch (psi) to 1,000 pounds psi after from 24 hours to 30 days, according to API RP 10B-2 (2019).

By way of non-limiting example, exemplary combinations applicable to A and B include any one, more, or all of Elements 1-9 in any combination.

The present disclosure is further directed to the following non-limiting embodiments.

Embodiment 1: A flowable universal fluid (UF) composition comprising a mixture of: an aqueous-based carrier fluid; an aluminosilicate material; a set retarding agent; a polyacrylamide viscosifier; and a fluid loss control agent; wherein the flowable UF composition exhibits: a HTHP fluid loss volume of from 10 milliliters (mL) to 50 mL; and/or a HTHP filter cake thickness of from 5/32″ to 1″, as measured by API 13B-1 (2023); and wherein, upon contact with an alkaline activator, the activated flowable UF composition is capable of solidifying under formation temperature conditions, thereby forming a solidified UF composition.

Embodiment 2. The flowable UF composition of Embodiment 1, wherein the flowable UF composition exhibits: a HTHP fluid loss volume of from 10 milliliters (mL) to 25 mL; and/or a filter cake thickness of from 5/32″ to 15/32″, as measured by API 13B-1 (2023).

Embodiment 3. The flowable UF composition of Embodiment 1 or Embodiment 2, wherein the aluminosilicate material comprises at least one component selected from the group consisting of fly ash, slag, and any combination thereof.

Embodiment 4. The flowable UF composition of any one of Embodiments 1-3, wherein the fluid loss control agent comprises at least one component selected from the group consisting of modified starch polymers, styrene butadiene polymers, salts thereof, and any combination thereof; and/or wherein the fluid loss control agent comprises at least one component selected from the group consisting of nonionic fluid loss control agents, anionic fluid loss control agents, salts thereof, and any combination thereof.

Embodiment 5. The flowable UF composition of any one of Embodiments 1-4, wherein, when the aluminosilicate material comprises slag, the fluid loss control agent comprises at least one component selected from the group consisting of nonionic modified starch polymers, nonionic styrene butadiene polymers, and any combination thereof.

Embodiment 6. The flowable UF composition of any one of Embodiments 1-5, wherein the polyacrylamide viscosifier comprises at least one component selected from the group consisting of anionic polyacrylamides, partially hydrolyzed polyacrylamides, salts thereof.

Embodiment 7. The flowable UF composition of any one of Embodiments 1-6, wherein the flowable UF composition comprises: the aluminosilicate material at from 40 weight % (wt %) to 60 wt %; the set retarding agent at from 0.5 wt % to 1.5 wt %; the polyacrylamide viscosifier at from 0.1 wt % to 0.5 wt %; and/or the fluid loss control agent at from 0.5 wt % to 1 wt %.

Embodiment 8. The flowable UF composition of any one of Embodiments 1-7, wherein the flowable UF composition comprises at least one component selected from the group consisting of a salt, a pH adjuster, and any combination thereof.

Embodiment 9. The flowable UF composition of any one of Embodiments 1-8, wherein the flowable UF composition exhibits: a plastic viscosity at 120° F. of from 25 centipoise (cP) to 50 cP; a yield point at 120° F. of from 15 foot-pounds per 100 square feet (lbf/100 ft²) to 40 lbf/100 ft²; and/or a low shear yield point at 120° F. of from 1 lbf/100 ft² to 6 lbf/100 ft², as measured by API 13B-1 (2023).

Embodiment 10. The flowable UF composition of any one of Embodiments 1-9, wherein, upon contact at 250° F. of the flowable UF composition with an alkaline activator at from 5 weight percent (wt %) to 20 wt %, based on the total weight of the aluminosilicate material: the flowable UF composition exhibits a 70 Bearden consistency unit (70 Bc) thickening time of from one hour to three hours; and/or the solidified UF composition exhibits a compressive strength of from 100 pounds per square inch (psi) to 15,000 pounds psi after from 24 hours to 30 days, according to API RP 10B-2 (2019).

Embodiment 11. A method comprising: providing a flowable universal fluid (UF) comprising: a mixture of: an aqueous-based carrier fluid; an aluminosilicate material; a set retarding agent; a polyacrylamide viscosifier; and a fluid loss control agent, wherein the flowable UF composition exhibits: a HTHP fluid loss volume of from 10 milliliters (mL) to 50 mL; and/or a HTHP filter cake thickness of from 5/32″ to 1″, as measured by API 13B-1 (2023); drilling a wellbore in a subterranean formation using the flowable UF composition, wherein at least a portion of the flowable UF composition remains in the wellbore upon completion of the drilling; introducing an alkaline activator into the wellbore, thereby contacting the remaining flowable UF composition therein with the alkaline activator; and allowing the activated flowable UF composition in the wellbore to solidify under formation temperature conditions, thereby forming a solidified UF composition in the wellbore.

Embodiment 12. The method of Embodiment 11, wherein the flowable UF composition exhibits: a HTHP fluid loss volume of from 10 milliliters (mL) to 25 mL; and/or a HTHP filter cake thickness of from 5/32″ to 15/32″, as measured by API 13B-1 (2023).

Embodiment 13. The method of Embodiment 11 or Embodiment 12, wherein the aluminosilicate material comprises at least one component selected from the group consisting of fly ash, slag, and any combination thereof.

Embodiment 14. The method of anyone of Embodiments 11-13, wherein the fluid loss control agent comprises at least one component selected from the group consisting of modified starch polymers, styrene butadiene polymers, salts thereof, and any combination thereof; and/or wherein the fluid loss control agent comprises at least one component selected from the group consisting of nonionic fluid loss control agents, anionic fluid loss control agents, salts thereof, and any combination thereof.

Embodiment 15. The method of any one of Embodiments 11-14, wherein, when the aluminosilicate material comprises slag, the fluid loss control agent comprises at least one component selected from the group consisting of nonionic modified starch polymers, nonionic styrene butadiene polymers, and any combination thereof.

Embodiment 16. The method of any one of Embodiments 11-15, wherein the polyacrylamide viscosifier comprises at least one component selected from the group consisting of anionic polyacrylamides, partially hydrolyzed polyacrylamides, salts thereof, and any combination thereof.

Embodiment 17. The method of any one of Embodiments 11-16, wherein the flowable UF composition comprises: the aluminosilicate material at from 40 weight % (wt %) to 60 wt %; the set retarding agent at from 0.5 wt % to 1.5 wt %; the polyacrylamide viscosifier at from 0.1 wt % to 0.5 wt %; and/or the fluid loss control agent at from 0.5 wt % to 1 wt %.

Embodiment 18. The method of any one of Embodiments 11-17, wherein the flowable UF composition comprises at least one component selected from the group consisting of a salt, a pH adjuster, and any combination thereof.

Embodiment 19. The method of any one of Embodiments 11-18, wherein the flowable UF composition exhibits: a plastic viscosity at 120° F. of from 25 centipoise (cP) to 50 cP; a yield point at 120° F. of from 15 foot-pounds per 100 square feet (lbf/100 ft²) to 40 lbf/100 ft²; and/or a low shear yield point at 120° F. of from 1 lbf/100 ft² to 6 lbf/100 ft², as measured by API 13B-1 (2023).

Embodiment 20. The method of any one of Embodiments 11-19, wherein, upon contact at 250° F. of the flowable UF composition with an alkaline activator at from 5 weight percent (wt %) to 20 wt %, based on the total weight of the aluminosilicate material: the flowable UF composition exhibits a 70 Bearden consistency unit (70 Bc) thickening time of from one hour to three hours; and/or the solidified UF composition exhibits a compressive strength of from 100 pounds per square inch (psi) to 15,000 pounds psi after from 24 hours to 30 days, as measured by API RP 10B-2 (2019).

To facilitate a better understanding of the aspects of the present disclosure, the following examples of preferred or representative aspects are given. In no way should the following examples be read to limit, or to define, the scope of the disclosure.

### Examples

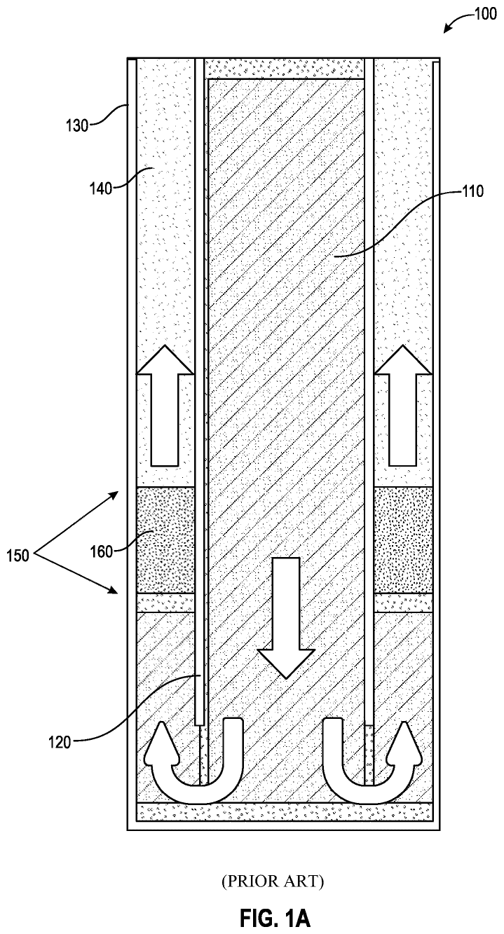

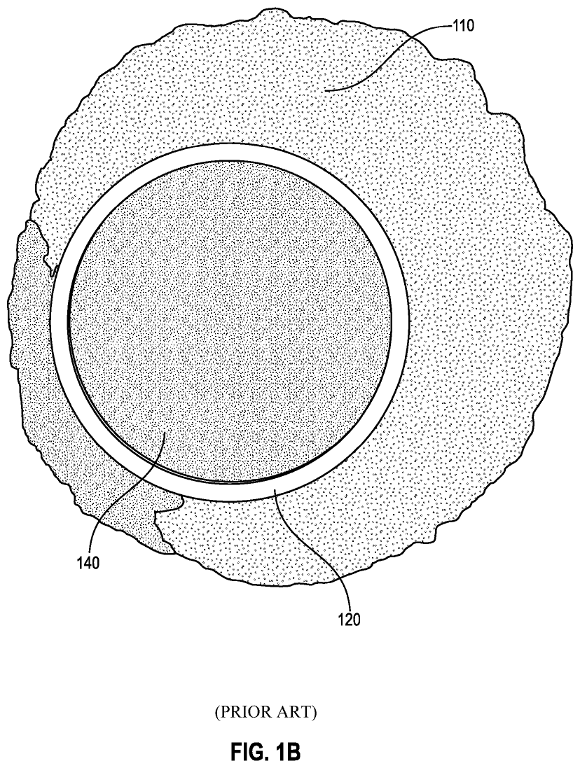

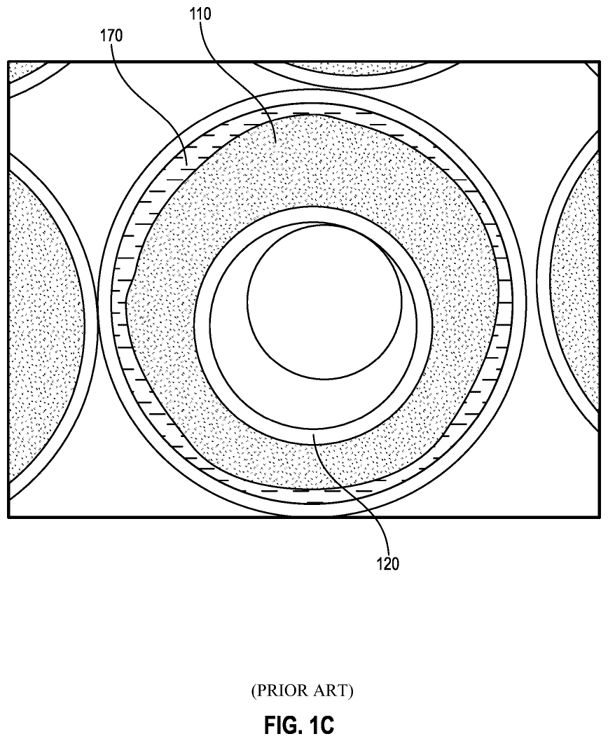

As shown in FIG. 1A, the main function of cementing is to provide zonal isolation between the various formations penetrated by the wellbore 100. This is achieved by injecting a mixture of cement slurry 110 into the space between a casing 120 and the surrounding formation or a previous casing 130. When transitioning between a drilling operation and a cementing operation, drilling fluid 140 may be cleansed from the wellbore 100 using a clean-up spacer fluid 160. Ideally, transitions between the drilling fluid 140 and the spacer fluid 160 and between the spacer fluid 160 and the cement slurry 110 are sharp interfaces 150 which move upward within the annulus during the cementing process. However, the spacer fluid 160 does not always fully displace the drilling fluid 140, resulting in drilling fluid 110 remaining in the annular area after cementing and during subsequent operations, e.g., additional drilling (FIG. 1B). Consequently, fluid channels 170 may remain in the annular area (FIG. 1C), resulting in inadequate zonal isolation, allowing for potential communication between different zones. This can be detrimental to the integrity of the wellbore, especially considering the non-settling properties of conventional drilling fluid systems.

To address this problem, a universal fluid (UF) system is proposed which acts as a drilling fluid and transforms into a solid cement sheath when activated, ensuring wellbore integrity. However, fluid loss control at temperatures of 250° F. or greater remains a significant challenge for traditional UF systems. The proposed UF system uses sustainable materials (such as fly ash or blast furnace slag) versus conventional Portland cement to reduce the carbon footprint while achieving a field-ready rheology, good cement strength, controllable mud-to-cement transition processes, and significant improvements in fluid loss control properties under temperature conditions of 250° F. or greater.

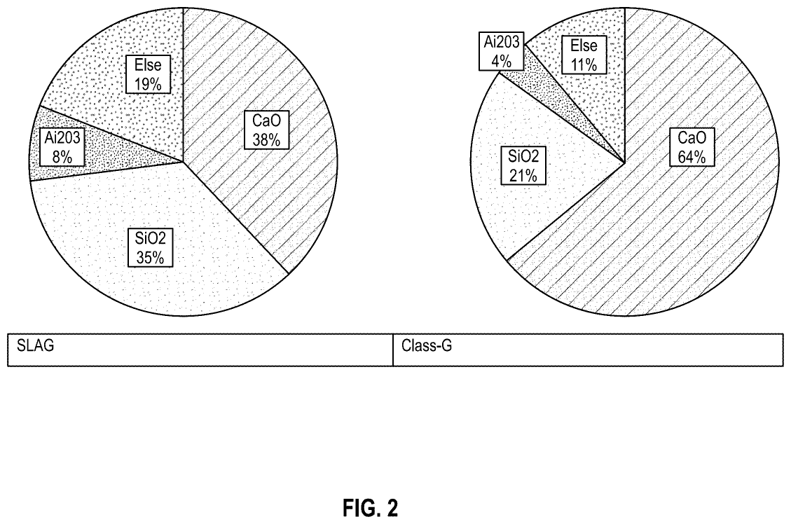

EXAMPLE 1: SLAG-BASED UF COMPOSITIONS: As mentioned earlier, the control of fluid loss is a significant challenge when it comes to UF systems operating under high temperature conditions (e.g., 250° F. or greater). FIG. 2 illustrates the compositions of blast furnace slag cement precursor (“slag”) and Class-G Portland cement particles. Table 1 presents the composition, surface, charge, and particle sizes of slag and Glass-G Portland cement, in comparison to SiO₂, CaCO₃, and Barite (BaSO₄) particles. Both slag and Glass-G Portland cement particles share similar compositions, albeit with varying amounts of CaO, SiO₂, and Al₂O₃.

TABLE 1A

| | | Class-G | | | |
|---|---|---|---|---|---|
| | | Portland | | | |
| Particles | Slag | Cement | SiO₂ | CaCO₃ | Barite |
| Composition | 38% CaO | 64% CaO | — | — | BaSO₄ |
| | 35% SiO₂ | 21% SiO₂ | | | |
| | 8% Al₂O₃ | 8% Al₂O₃ | | | |
| Surface Charge | Mixed (net | Mixed (net | negative | positive | negative |
| in 10% NaCl | negative) | negative) | | | |
| Particle Size | 15 | 20 | 75 | 25 | 17 |

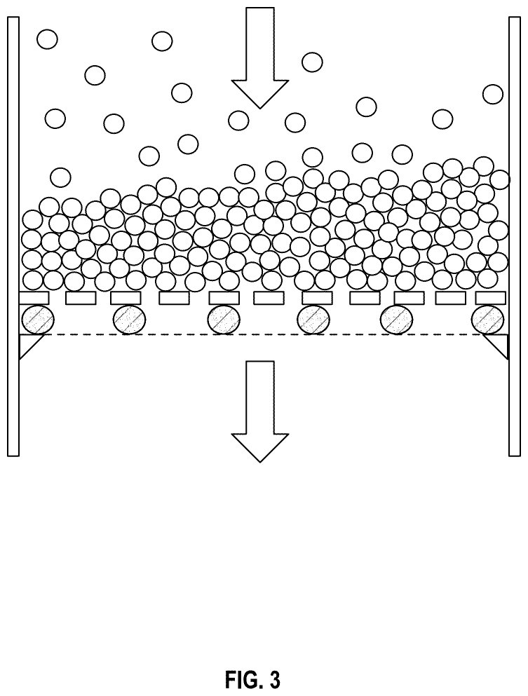

FIG. 3 shows a schematic of how filtrate flows through a formed filter cake during API HTHP testing according to test method API 13B-1 as described herein (at 250° F., a differential pressure of 500 psi, 73 ml volume, where prior to testing, samples are heat rolled at 250° F. (121.1° C.) for 16 hours), which was used to evaluate fluid loss and filter cake thickness of UF fluid systems incorporating the particles of Table 1A. A typical composition for a high temperature UF system was used, including 200 g particles, 140 g of DI water, 14 g of NaCl, 1 g of pH adjuster (soda ash), 1 g of high temperature viscosifier (Hyperdrill® DP/AF 8202 XP (SNF), an anionic water-soluble acrylamide co-polymer, 4 g of set retarder (BioDrill® RC502 (Borregaard), a calcium lignosulfonate), and), 3 g of a fluid loss control agent (StarPak® Extreme (Chemstar, an anionic modified starch). Table 1B shows the fluid loss and filter cake thickness of traditional UF systems comprising the particles of Table 1A after API HTHP testing as described herein.

TABLE 1B
API 13B-1 (2023): Fluid Loss/Filter Cake Thickness

| | | Class-G | | | |
|---|---|---|---|---|---|
| | | Portland | | | |
| Particles | Slag | Cement | SiO₂ | CaCO₃ | Barite |
| Fluid Loss (mL) | 72 | 30.8 | 15.2 | 14.8 | 13.2 |
| Filter Cake Thickness (in.) | 1 4/16 | 11/32 | 9/32 | 7/32 | 4/32 |

Among these five fluid systems, slag exhibits the highest fluid loss and the thickest filter cake in the API HTHP test. The barite fluid system formed a thin filter cake, measuring approximately 4/32 inches in thickness. The SiO₂ and CaCO₃ systems showed similar filter cake thickness, despite the former possessing a negatively charged surface and the latter having a positive charge, as indicated in Table 1A. The results for the SiO₂, CaCO₃, and barite systems suggest that the UF formulation (excluding the particles) can generate thin filter cakes and minimize fluid loss for these three fluid systems. These three systems exhibit predominantly positive or negative surface charges on the particles.

In contrast, the slag and Class-G Portland cement particles have more heterogeneously charged surfaces, with positively charged binding sites from CaO and negatively charged binding sites from SiO₂ or Al₂O₃. However, it is estimated that the surface charges of slag and Class-G Portland cement are net negative, particularly at higher pH values (e.g., 10-12). As the content and ratio of CaO, SiO₂, and Al₂O₃ differ, the results demonstrate variations in fluid loss and filter cake thickness. The slag-based UF fluid system exhibits high fluid loss of 72 mL in this case, along with a thick filter cake measuring 1 4/16 inches in thickness. Conversely, the Class-G Portland cement system shows a fluid loss of 30.8 mL, which is only 45% of the slag-based fluid system, with a thinner filter cake measuring 11/32 inches in thickness. These findings highlight the significance of surface charge distribution in governing fluid loss control under high temperature conditions.

A modified slag-based UF system was based on the formulation above, except, to address the complexity of the surface charge of slag, a neutral charged polymer, specifically a dispersible neutral charge styrene-butadiene (biopolymer styrene-butadiene terpolymer XD5043PD (OMNOVA)) was incorporated as the fluid loss control agent. Table 2 shows the fluid loss and filter cake thickness of the modified slag-based UF system after API HTHP testing as described herein.

TABLE 2
Slag - API 13B-1 (2023): Fluid Loss/Filter Cake Thickness

| Fluid Loss Control Agent | Styrene Butadiene (OMNOVA) |
|---|---|
| Fluid Loss (mL) | 41.2 |
| Filter Cake Thickness (in.) | 20/32 |

The addition of neutral charge styrene butadiene resulted in a reduction of fluid loss volume from 70.2 mL to 41.2 mL, while also decreasing the filter cake thickness from 1¼ to 20/32 inches, a significant improvement over traditional UF systems using anionic fluid loss control agents. These improvements can be attributed to two key properties of the neutral charge styrene butadiene: 1) it exhibits weak interactions with the particles; and 2) its softening nature under 250° F. allows it to effectively seal the pores of the slag-based filter cake.

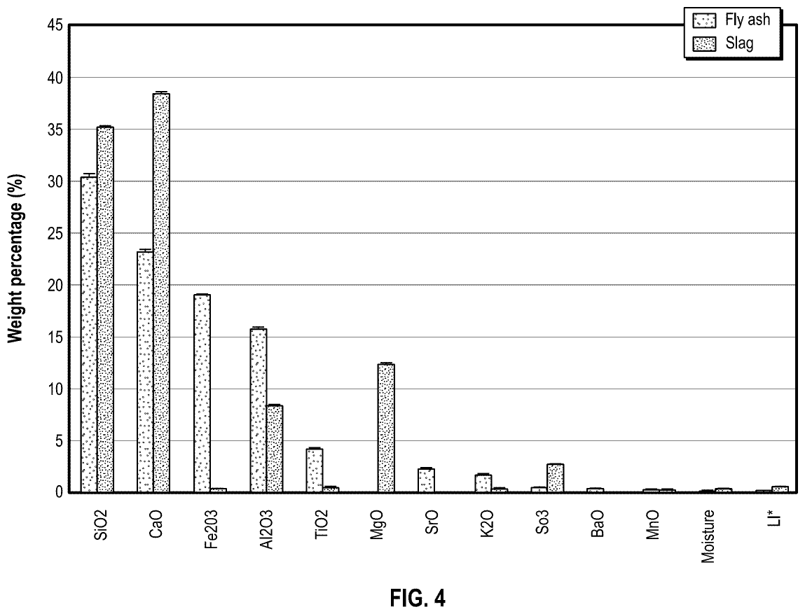

EXAMPLE 2: FLY ASH-BASED UF COMPOSITIONS: In this Example, the composition of a fly ash cement precursor (“fly ash”) and slag for use in a UF composition were evaluated using x-ray fluorescence spectroscopy (XRF) (FIG. 4). The various components of the two geopolymer cement precursors overlap and include: silicon dioxide (SiO₂), calcium oxide (CaO), iron oxide (Fe₂O₃), aluminum oxide (Al₂O₃), titanium dioxide (TiO₂), and magnesium oxide (MgO); smaller amounts of strontium oxide (SrO), potassium oxide (K₂O), sulfur trioxide (SO₃), barium oxide (BaO), manganese oxide (MnO); and trace amounts of moisture and organic matter loss upon ignition (LI). The primary components shared by each cement precursor are SiO₂ (about 30 wt % to about 35 wt %), CaO (about 20 wt % to about 40 wt %), and Al₂O₃ (about 5 wt % to about 15 wt %). The fly ash, although sharing a similar composition with slag, differs in the content of SiO₂, CaO, and Al₂O₃, resulting in distinct surface charges between the two, although both are expected to have net negative surface charges, particularly under high pH conditions (e.g., 10-12).

Table 3 provides experimental data for API HTHP fluid loss performance at 250° F. of fly ash-based UF systems. A modified formulation for a fly ash-based UF system was used, including 200 grams (g) of fly ash, 140 g of DI water, 14 g of NaCl, 1 g of pH adjuster (soda ash), 1 g of high temperature viscosifier (Hyperdrill® DP/AF 8202 XP (SNF), an anionic water-soluble acrylamide co-polymer), 4 g of set retarder (BioDrill® RC502 (Borregaard), a calcium lignosulfonate), and 3 g of one of four different types of modified starch, including both anionic and nonionic variants, as the fluid loss control agent: StarPak® II (Chemstar) (anionic); StarPak® Extreme (Chemstar) (anionic); ExStar® HT (Chemstar) (nonionic); or RheoStar® D(Chemstar). Table 3 shows the fluid loss and filter cake thickness of the modified fly ash-based UF system after API HTHP testing as described herein.

TABLE 3
Fly Ash - API 13B-1 (2023): Fluid Loss/Filter Cake Thickness

| | StarPak ® | StarPak ® | RheoStar ® | ExStar ® |
|---|---|---|---|---|
| Fluid Loss | II | Extreme | D | HT |
| Control Agent | (anionic) | (anionic) | (nonionic) | (nonionic) |
| Fluid Loss (mL) | 18.4 | 18.0 | 18.4 | 16.8 |
| Filter Cake | 9/32 | 9/32 | 10/32 | 9/32 |
| Thick. (in.) | | | | |

When exposed to high temperature conditions, the fly ash-based UF system containing modified starch demonstrated notable enhancements in fluid loss control and reduced filter cake thickness. There were no discernible differences observed in terms of fluid loss control and filter cake thickness between the modified starches tested. The fly ash-based UF system with modified starch fluid loss control agent exhibited significantly improved API HTHP fluid loss performance. The presence of modified starch reduced the fluid loss volume from 70.4 mL to approximately 17-18 mL, representing a 75% reduction, while decreasing the filter cake thickness from 1 4/16 inches to from 9/32 to 10/32 inches.

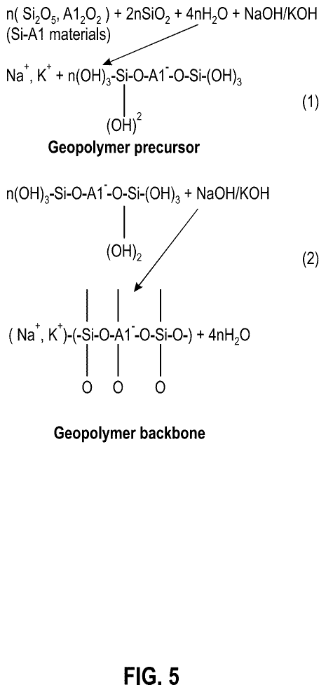

EXAMPLE 3: RHEOLOGY OF FLY ASH-BASED UF COMPOSITIONS PRIOR TO ACTIVATION: As shown in Examples 1 and 2, furnace slag and fly ash geopolymer cement precursors predominantly contain SiO₂, CaO, and Al₂O₃. Under alkaline conditions, the silica and alumina species present in these materials undergo a reaction, leading to the formation of a geopolymer. The step-by-step progression of the geopolymerization process is visually depicted in FIG. 5. The interaction between the silica and alumina species and alkaline agents produces geopolymer precursors (FIG. 5, Equation 1), which ultimately transform into a solid geopolymer cement (FIG. 5, Equation 2).

In this Example, the rheology of a fly ash-based UF composition was evaluated, prior to the addition of an activator. An “optimum” rheology for a UF composition can be characterized by a low “plastic viscosity” (PV) (e.g., 0-40 cP), a high “yield point” (YP) (e.g., 10-25 lb/100 ft²), and a high “low shear yield point” (LSYP) (e.g., 5-8 lb/100 ft²). A modified formulation for a fly ash-based UF system was used, including 200 grams (g) of fly ash, 140 g of DI water, 14 g of NaCl, 1 g of pH adjuster (soda ash), 1 g of high temperature viscosifier (Hyperdrill® DP/AF 8202 XP (SNF), an anionic water-soluble acrylamide co-polymer), 4 g of set retarder (BioDrill® RC502 (Borregaard), a calcium lignosulfonate), and 3 g of one of four different types of modified starch, including both anionic and nonionic variants (see Table 4), as the fluid loss control agent. Table 4 shows the rheology of the modified fly ash-based UF systems after API HTHP testing as described herein.

TABLE 4
Fly Ash - API 13B-1 (2023): Rheology

| | | StarPak ® | StarPak ® | RheoStar ® | ExStar ® |
|---|---|---|---|---|---|
| Fluid Loss | | II | Extreme | D | HT |
| Control Agent | | (anionic) | (anionic) | (nonionic) | (nonionic) |
| RPM | | DR | DR | DR | DR |
| 600 | | 114 | 121 | 106 | 106 |
| 300 | | 69 | 75 | 67 | 67 |
| 200 | | 50 | 56 | 51 | 51 |
| 100 | | 31 | 35 | 31 | 33 |
| 6 | | 5 | 7 | 6 | 8 |
| 3 | | 4 | 5 | 4 | 6 |
| 10 | s | 5 | 5 | 6 | 6 |
| 10 | min | 10 | 10 | 12 | 13 |

| | | | | |
|---|---|---|---|---|
| PV, cp | 45 | 46 | 39 | 39 |
| YP, lb/100 ft² | 24 | 29 | 28 | 28 |
| LSYP, lb/100 ft² | 3 | 3 | 2 | 4 |

The results in Table 4 show that ExStar® HT and RheoStar® D show lower PV than StarPak® II and StarPak® Extreme. StarPak® Extreme, Exstar® HT and RheoStar® D shows similar YP, each higher than the YP of StarPak® II. Exstar® HT shows the highest LSYP of 4 lb/100 ft². The results indicate that ExStar® HT has the best fluid rheology modification for the high temperature fly ash-based UF system.

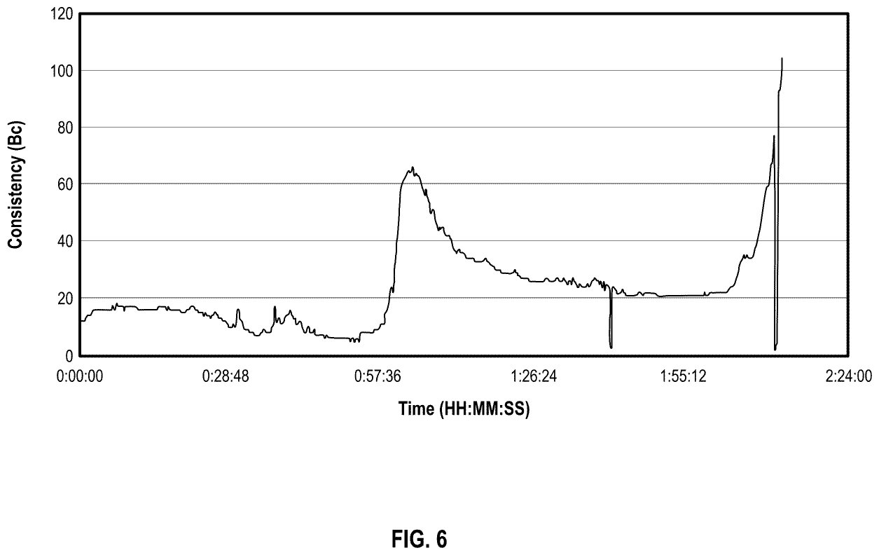

EXAMPLE 4: THICKENING TIME OF ACTIVATED FLY ASH-BASED UF COMPOSITIONS: In this Example, the thickening time period of a fly ash-based UF composition was evaluated according to API RP 10B-2 (2019) as described herein, in which the fly ash-based UF composition additionally included an activator. A modified formulation for a fly ash-based UF system was used, including 200 grams (g) of slag, 140 g of DI water, 14 g of NaCl, 1 g of pH adjuster (soda ash), 1 g of high temperature viscosifier (Hyperdrill® DP/AF 8202 XP (SNF), an anionic water-soluble acrylamide co-polymer), 4 g of set retarder (BioDrill® RC502 (Borregaard), a calcium lignosulfonate), and 3 g of modified starch 1 (StarPak® Extreme (Chemstar)) as the fluid loss control agent. Upon introducing 40 g of a 50 wt % NaOH solution into the fly ash-based UF composition, the thickening time (Bc=70) upon heating to 250° F. was recorded, as presented in FIG. 6. The UF fluid can undergo thickening within approximately two hours after activation.

EXAMPLE 4: COMPRESSION STRENGTH OF ACTIVATED AND SET SLAG-BASED UF COMPOSITIONS: In this Example, the compressive strength of an activated and set slag-based UF system was evaluated according to API RP 10B-2 (2019) as described herein. The slag-based UF system comprised 200 grams (g) slag, 140 g of DI water, 14 g of NaCl, 1 g of pH adjuster (soda ash), 1 g of high temperature viscosifier (Hyperdrill® DP/AF 8202 XP (SNF), an anionic water-soluble acrylamide co-polymer), 4 g of set retarder (BioDrill® RC502 (Borregaard), a calcium lignosulfonate), and 3 g of a dispersible neutral charged styrene butadiene(biopolymer styrene-butadiene terpolymer XD5043PD (OMNOVA)) as the fluid loss control agent. Additionally, 40 g of a 50 wt % NaOH solution was introduced to activate the UF system, transforming it from a fluid to a solid cement. The results indicate that the UF system achieved an average compressive strength of 1634±534 psi after 7 days of activation at 250° F.

Accordingly, the present disclosure provides compositions and methods for slag-based and fly ash-based UF fluids possessing all the essential properties required for an effective drilling fluid, while also offering zonal isolation capabilities as a settable cement material upon activation, including: desirable rheology, fluid loss control, pumpability (thickening time), and the like. The utilization of this type of UF fluid system eliminates the need for conventional Portland cement, making it a highly environmentally sustainable approach.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

It should be noted that when “about” is provided herein at the beginning of a numerical list, the term modifies each number of the numerical list. In some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, properties such as concentration, temperatures, and so forth used in the present specification and associated claims are to be understood as being modified in all instances by the term “about.” As used herein, the term “about” encompasses+/−5% of a numerical value. Accordingly, unless indicated to the contrary, the numerical parameters set forth in the following specification and attached claims are approximations that may vary depending upon the desired properties sought to be obtained by the exemplary embodiments described herein. At the very least, and not as an attempt to limit the application of the doctrine of equivalents to the scope of the claim, each numerical parameter should at least be construed in light of the number of reported significant digits and by applying ordinary rounding techniques.

Terms of orientation are used herein merely for purposes of convention and referencing and are not to be construed as limiting. However, it is recognized these terms could be used with reference to an operator or user.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention is not limited to the particular embodiments disclosed, or to the best mode contemplated for carrying out this invention, but that the invention will include all embodiments falling within the scope of the appended claims. Moreover, references in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1-10. (canceled)

11. A method comprising:
providing a flowable universal fluid (UF) comprising a mixture of:
an aqueous-based carrier fluid;
an aluminosilicate material;
a set retarding agent;
a polyacrylamide viscosifier; and
a fluid loss control agent comprising at least one component selected from the group consisting of an ether-substituted starch polymer, an ester-substituted starch polymer, a phosphorylated starch polymer, an oxidized starch polymer, a carboxymethylated starch polymer, a styrene-butadiene polymer, and any combination thereof,
wherein the fluid loss control agent is selected to match a surface charge of the aluminosilicate material, and
wherein the flowable UF composition exhibits:
a high temperature/high-pressure (HTHP) fluid loss volume of from 10 milliliters (mL) to 50 mL; and/or
a HTHP filter cake thickness of from 5/32″ to 1″,
as measured by API 13B-1 (2023);
drilling a wellbore in a subterranean formation using the flowable UF composition, wherein at least a portion of the flowable UF composition remains in the wellbore upon completion of the drilling;
introducing an alkaline activator into the wellbore, thereby contacting the remaining flowable UF composition therein with the alkaline activator; and
allowing the activated flowable UF composition in the wellbore to solidify under formation temperature conditions, thereby forming a solidified UF composition in the wellbore.

12. The method of claim 11, wherein the flowable UF composition exhibits:
a HTHP fluid loss volume of from 10 milliliters (mL) to 25 mL; and/or
a HTHP filter cake thickness of from 5/32″ to 15/32″,
as measured by API 13B-1 (2023).

13. The method of claim 11, wherein the aluminosilicate material comprises at least one component selected from the group consisting of fly ash, slag, and any combination thereof.

14. The method of claim 11, wherein the fluid loss control agent comprises at least one component selected from the group consisting of nonionic fluid loss control agents, anionic fluid loss control agents, salts thereof, and any combination thereof.

15. The method of claim 11, wherein the aluminosilicate material is slag, and the fluid loss control agent is nonionic.

16. The method of claim 11, wherein the polyacrylamide viscosifier comprises at least one component selected from the group consisting of anionic polyacrylamides, partially hydrolyzed polyacrylamides, salts thereof, and any combination thereof.

17. The method of claim 11, wherein the flowable UF composition comprises:
the aluminosilicate material at from 40 weight % (wt %) to 60 wt %;
the set retarding agent at from 0.5 wt % to 1.5 wt %;
the polyacrylamide viscosifier at from 0.1 wt % to 0.5 wt %; and/or
the fluid loss control agent at from 0.5 wt % to 1 wt %.

18. The method of claim 11, wherein the flowable UF composition comprises at least one component selected from the group consisting of a salt, a pH adjuster, and any combination thereof.

19. The method of claim 11, wherein the flowable UF composition exhibits:
a plastic viscosity at 120° F. of from 25 centipoise (cP) to 50 cP;
a yield point at 120° F. of from 15 foot-pounds per 100 square feet (lbf/100 ft²) to 40 lbf/100 ft²; and/or
a low shear yield point at 120° F. of from 1 lbf/100 ft² to 6 lbf/100 ft², as measured by API 13B-1 (2023).

20. The method of claim 11, wherein, upon contact at 250° F. of the flowable UF composition with an alkaline activator at from 5 weight percent (wt %) to 20 wt %, based on the total weight of the aluminosilicate material:
the flowable UF composition exhibits a 70 Bearden consistency unit (70 Bc) thickening time of from one hour to three hours; and/or
the solidified UF composition exhibits a compressive strength of from 100 pounds per square inch (psi) to 15,000 pounds psi after from 24 hours to 30 days,
as measured by API RP 10B-2 (2019).

21. The method of claim 13, wherein the aluminosilicate material is fly ash, and the fluid loss control agent is nonionic or anionic.

22. The method of claim 13, wherein the aluminosilicate material is fly ash, and the fluid loss control agent is nonionic or anionic, or wherein the aluminosilicate material is slag, and the fluid loss control agent is nonionic.

23. The method of claim 11, wherein the fluid loss control agent is selected to match a neutral fluid loss control agent with an aluminosilicate material having a neutral surface charge and a neutral or anionic fluid loss control agent with an aluminosilicate material having an anionic surface charge.

24. A method comprising:
providing a flowable universal fluid (UF) comprising a mixture of:
an aqueous-based carrier fluid;
an aluminosilicate material;
a set retarding agent;
a polyacrylamide viscosifier; and
a fluid loss control agent comprising a styrene-butadiene polymer,
wherein the flowable UF composition exhibits:
a high temperature/high-pressure (HTHP) fluid loss volume of from 10 milliliters (mL) to 50 mL; and/or
a HTHP filter cake thickness of from 5/32″ to 1″,
as measured by API 13B-1 (2023);
drilling a wellbore in a subterranean formation using the flowable UF composition, wherein at least a portion of the flowable UF composition remains in the wellbore upon completion of the drilling;
introducing an alkaline activator into the wellbore, thereby contacting the remaining flowable UF composition therein with the alkaline activator; and
allowing the activated flowable UF composition in the wellbore to solidify under formation temperature conditions, thereby forming a solidified UF composition in the wellbore.

25. The method of claim 24, wherein the flowable UF composition exhibits:
a HTHP fluid loss volume of from 10 milliliters (mL) to 25 mL; and/or
a HTHP filter cake thickness of from 5/32″ to 15/32″,
as measured by API 13B-1 (2023).

26. The method of claim 24, wherein the aluminosilicate material comprises at least one component selected from the group consisting of fly ash, slag, and any combination thereof.

27. The method of claim 24, wherein the polyacrylamide viscosifier comprises at least one component selected from the group consisting of anionic polyacrylamides, partially hydrolyzed polyacrylamides, salts thereof, and any combination thereof.

28. The method of claim 24, wherein the flowable UF composition comprises:
the aluminosilicate material at from 40 weight % (wt %) to 60 wt %;
the set retarding agent at from 0.5 wt % to 1.5 wt %;
the polyacrylamide viscosifier at from 0.1 wt % to 0.5 wt %; and/or
the fluid loss control agent at from 0.5 wt % to 1 wt %.

29. The method of claim 24, wherein the flowable UF composition comprises at least one component selected from the group consisting of a salt, a pH adjuster, and any combination thereof.

30. The method of claim 24, wherein the flowable UF composition exhibits:
a plastic viscosity at 120° F. of from 25 centipoise (cP) to 50 cP;
a yield point at 120° F. of from 15 foot-pounds per 100 square feet (lbf/100 ft²) to 40 lbf/100 ft²; and/or
a low shear yield point at 120° F. of from 1 lbf/100 ft² to 6 lbf/100 ft², as measured by API 13B-1 (2023).
